(19) United States
(12) Patent Application Publication
(10) Pub. No.: US 2026/0033674 A1
(43) Pub. Date: Feb. 5, 2026

(54) Cutting Board with Removable Sidewall

(71) Applicant: Jonathan Tabler, Mount Pleasant, SC (US)

(72) Inventor: Jonathan Tabler, Mount Pleasant, SC (US)

(21) Appl. No.: 19/286,503

(22) Filed: Jul. 31, 2025

Related U.S. Application Data
(60) Provisional application No. 63/678,480, filed on Aug. 1, 2024.

(51) Int. Cl. A47J 47/00

(52) U.S. Cl. CPC A47J 47/005

(57) ABSTRACT

A cutting board apparatus includes a base member with a cutting surface and four sidewalls extending upwardly from the edges of the base member to contain food items during cutting operations. Three sidewalls are fixed to the base member while a fourth sidewall is removably coupled through retention mechanisms disposed on the two opposing sidewalls. The retention mechanisms allow the removable sidewall to be secured in an installed position during cutting operations and to be disengaged and removed when transfer of prepared ingredients is desired. When installed, the four sidewalls create a complete perimeter barrier preventing food scatter. When the fourth sidewall is removed, an unobstructed opening is created at one edge of the cutting board, enabling direct transfer of cut ingredients into cooking vessels or containers without tilting the board or using additional tools. The apparatus improves food preparation efficiency while reducing waste and maintaining kitchen cleanliness.

### CROSS-REFERENCE TO RELATED APPLICATIONS

This application claims the benefit of priority under 35 U.S.C. § 119(e) to U.S. Provisional Patent Application No. 63/678,480, filed on 1 Aug. 2024, the entire contents of which are hereby incorporated by reference in their entirety.

### FIELD OF INVENTION

The present invention relates to food preparation equipment, and more particularly to cutting boards. The invention specifically pertains to a cutting board design incorporating selectively removable wall sections to facilitate the transfer of prepared ingredients.

### BACKGROUND

The preparation of food ingredients through cutting, chopping, dicing, and mincing operations represents one of the most fundamental and frequently performed tasks in both residential and commercial kitchens. Traditional cutting boards have remained largely unchanged in their basic design for decades, consisting primarily of flat surfaces made from various materials such as wood, plastic, bamboo, or composite materials. While these conventional cutting boards adequately provide a stable surface for cutting operations, they suffer from numerous limitations that compromise both the efficiency of food preparation and the cleanliness of the kitchen environment. During typical cutting operations, the kinetic energy imparted by knife strokes, combined with the natural tendency of cut food pieces to scatter, results in food items frequently escaping the boundaries of the cutting surface. This phenomenon is particularly pronounced when working with round or cylindrical ingredients such as cherry tomatoes, grapes, or olives, or when performing rapid chopping motions with herbs, vegetables, or other ingredients.

The loss of food items from the cutting surface during preparation creates multiple problems that extend beyond mere inconvenience. First, food pieces that fall onto countertops or floors represent both a waste of ingredients and a potential safety hazard, as they can create slippery conditions that may lead to accidents in the kitchen. Second, the need to repeatedly gather scattered food items interrupts the workflow of food preparation, significantly reducing efficiency and increasing the time required to complete cooking tasks. Third, the scattering of food particles necessitates additional cleaning efforts, as ingredients that contact surfaces beyond the cutting board may contaminate those surfaces and require thorough sanitization. This is particularly problematic in commercial kitchen environments where food safety regulations demand strict adherence to cleanliness standards and where cross-contamination must be avoided at all costs.

The transfer of prepared ingredients from cutting surfaces to cooking vessels or storage containers represents another significant challenge in kitchen operations. Traditional flat cutting boards require users to employ various techniques to move cut ingredients, each with its own disadvantages. The common practice of using a knife blade to scrape ingredients to the edge of the board and then into a container risks dulling the knife edge and can be dangerous if not performed carefully. Alternatively, lifting and tilting the entire cutting board to slide ingredients into a vessel can be cumbersome, particularly with larger boards or when only a portion of the prepared ingredients needs to be transferred while reserving others on the board. The use of bench scrapers or similar tools adds an extra step to the process and requires additional equipment that must be cleaned and stored. Furthermore, when preparing multiple ingredients that must be kept separate, such as when organizing mise en place for complex recipes, the limitations of traditional cutting boards become even more apparent, as there is no effective way to segregate different ingredients on the same cutting surface without risk of mixing or cross-contamination.

The evolution of cooking practices and kitchen design has further highlighted the inadequacies of traditional cutting board designs. Modern cooking techniques often emphasize efficiency, organization, and the precise timing of ingredient additions to dishes. The growing popularity of meal preparation strategies, where multiple meals' worth of ingredients are prepared in advance, requires cutting boards that can accommodate larger volumes of ingredients while maintaining organization and preventing waste. Additionally, the increasing awareness of food safety and hygiene in both home and commercial kitchens demands cutting surfaces that not only facilitate clean food preparation but also minimize the potential for cross-contamination between different ingredients. Contemporary kitchen designs, which often feature limited counter space and emphasize multifunctional tools, create a need for cutting boards that maximize usability while minimizing the workspace required for food preparation tasks. The traditional flat cutting board, unchanged in its fundamental design for generations, fails to meet these evolving needs and creates inefficiencies that impact both the enjoyment of cooking and the quality of the final prepared dishes.

It is within this context that the present invention is provided.

### SUMMARY

The present invention provides a cutting board apparatus that addresses the limitations of conventional cutting boards by incorporating a unique combination of structural features that contain food items during cutting operations while facilitating efficient transfer of prepared ingredients. The cutting board apparatus comprises a base member having a cutting surface, three fixed sidewalls extending upwardly from three edges of the base member, and a fourth removable sidewall that can be selectively installed or removed from the fourth edge of the base member. The removable sidewall is secured in place through retention mechanisms disposed on the two opposing sidewalls adjacent to the fourth edge, allowing the fourth sidewall to engage with these retention mechanisms when containment is desired and to disengage when transfer of ingredients is required.

This innovative configuration provides significant advantages over traditional flat cutting boards and existing designs with fixed raised edges. The three fixed sidewalls create a containment barrier that prevents food items from scattering during cutting, chopping, and dicing operations, thereby reducing waste, improving kitchen cleanliness, and enhancing food preparation efficiency. The removable fourth sidewall completes the containment system when installed, providing full perimeter protection against food scatter. When removed, the open fourth edge creates an unobstructed pathway for transferring prepared ingredients directly from the cutting surface into cooking vessels, storage containers, or other receptacles without the need for awkward tilting, scooping, or scraping operations that characterize traditional cutting board use.

In some embodiments, the retention mechanisms comprise grooves formed in the opposing sidewalls, providing a simple yet effective means for securing the removable sidewall. This groove-based retention system enables smooth installation and removal of the fourth sidewall without requiring complex latching mechanisms or tools, thereby maintaining the ease of use essential for efficient kitchen operations.

In further embodiments, the removable sidewall includes lateral edges configured to slidably engage with the grooves, creating a secure yet easily reversible connection. This sliding engagement mechanism ensures that the removable sidewall remains firmly in place during cutting operations while allowing for quick removal when ingredient transfer is desired.

In yet further embodiments, the removable sidewall is configured to be removed by sliding in an upward direction relative to the base member. This upward sliding motion provides an intuitive and ergonomic removal action that can be performed with one hand, leaving the other hand free to position a receiving vessel or to stabilize the cutting board during the transfer operation.

In some embodiments, the base member and the three fixed sidewalls are integrally formed as a unitary structure. This integral construction eliminates joints or seams between these components, preventing food particles and liquids from becoming trapped in crevices, thereby enhancing sanitation and simplifying cleaning procedures.

In further embodiments, transition regions between the cutting surface and the sidewalls comprise curved surfaces. These curved transitions eliminate sharp corners where food particles might accumulate and facilitate the smooth movement of ingredients across the cutting surface and toward the open edge when the removable sidewall is removed.

In yet further embodiments, corner regions between adjacent fixed sidewalls also comprise curved surfaces. These curved corners further enhance cleanability and prevent food accumulation while providing a more refined appearance to the cutting board apparatus.

In some embodiments, the cutting board apparatus is constructed from high-density polyethylene, providing excellent durability, chemical resistance, and food safety characteristics. This material choice ensures long service life even under demanding commercial kitchen conditions while maintaining compliance with food safety regulations.

In further embodiments, the base member and/or side walls may comprise various materials including polyethylene, polypropylene, bamboo, wood, or composite materials. This material flexibility allows the cutting board apparatus to be optimized for different use cases, aesthetic preferences, or specific performance requirements while maintaining the functional advantages of the sidewall system.

In yet further embodiments, anti-slip elements are disposed on the bottom surface of the base member. These anti-slip elements prevent unwanted movement of the cutting board during use, enhancing safety and allowing users to apply cutting force without concern for board stability.

In some embodiments, the anti-slip elements comprise rubberized feet that provide excellent grip on various countertop surfaces. These rubberized feet maintain their anti-slip properties even when exposed to water or food liquids, ensuring consistent stability throughout food preparation tasks.

In further embodiments, the sidewalls extend to predetermined heights above the cutting surface, with the height selected based on the dimensional size of the cutting surface. This height optimization ensures adequate food containment for different board sizes while preventing interference with natural cutting motions and knife handling.

In yet further embodiments, one or more sidewalls are oriented at an outward angle relative to perpendicular. This angled configuration not only facilitates easier cleaning of the interior corners but also enables efficient nesting of multiple cutting board units for space-saving storage and shipping.

In some embodiments, the base member and sidewalls may comprise different materials, allowing for optimization of each component's properties. For example, a bamboo cutting surface might be combined with polymer sidewalls to leverage the antimicrobial properties of bamboo while benefiting from the moldability and durability of engineered plastics.

In further embodiments, all sidewalls including the three fixed sidewalls are detachably coupled to the base member. This fully modular construction enables complete disassembly for thorough cleaning, replacement of worn components, or conversion of existing cutting boards through the addition of a sidewall assembly.

In yet further embodiments, the cutting board apparatus is manufactured through injection molding processes, with the base member and fixed sidewalls formed as one molded component and the removable sidewall formed as a separate molded component. This manufacturing approach enables cost-effective mass production while maintaining precise dimensional control and consistent quality across production runs.

### BRIEF DESCRIPTION OF THE DRAWINGS

Various embodiments of the invention are disclosed in the following detailed description and accompanying drawings.

FIG. 1 illustrates an example perspective view of the cutting board apparatus with all four sidewalls in place including the removable front sidewall secured in its installed position.

FIG. 2 illustrates an example front perspective view of the cutting board apparatus with the removable front sidewall lifted out and separated from the main board assembly.

FIG. 3 illustrates an example rear perspective view of the cutting board apparatus with the removable front sidewall lifted out and separated from the main board assembly.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The term “base member” as used herein refers to the primary structural component of the cutting board apparatus that provides the foundation upon which food preparation activities are performed. The base member includes the cutting surface and serves as the attachment point for the sidewalls. In exemplary implementations, the base member may be formed from a single piece of high-density polyethylene having a thickness ranging from 0.5 to 2.0 inches, or may comprise laminated bamboo strips bonded with food-safe adhesives, or may consist of end-grain hardwood blocks arranged in a butcher block configuration.

The term “sidewall” refers to any barrier structure that extends upwardly from the perimeter edges of the base member to create a containment region above the cutting surface. The sidewalls may extend perpendicular to the cutting surface or may be angled outward at angles ranging from 1 to 15 degrees from vertical. In one example implementation, sidewalls may have a height of 0.5 inches for small boards intended for herb preparation, while large commercial boards may feature sidewalls extending 2.0 to 3.0 inches above the cutting surface to accommodate high-volume food processing operations. The sidewalls may be comprised of a similar range of materials to the base member.

The term “retention mechanism” encompasses any structural feature or combination of features that enables the removable sidewall to be secured to and released from the cutting board apparatus. While the disclosed embodiments describe groove-based retention mechanisms, this term should be broadly construed to include alternative securing means such as magnetic coupling systems utilizing neodymium magnets embedded within the sidewall components, mechanical latches incorporating spring-loaded pins, bayonet-style twist-lock connections, or friction-fit arrangements utilizing elastomeric gaskets. In one implementation, the retention mechanism may comprise T-shaped grooves having a width of 0.25 inches and a depth of 0.375 inches, machined with tolerances of +0.005 inches to ensure smooth sliding operation while maintaining adequate retention force.

The term “removably coupled” indicates that the fourth sidewall can be repeatedly installed and removed from the base member without damage to either component and without requiring tools or excessive force. This coupling should withstand normal forces encountered during food preparation activities while permitting intentional removal through application of upward force in the range of 2 to 10 pounds. The removable coupling may be achieved through various mechanisms including the disclosed sliding groove arrangement, magnetic attachment systems providing holding forces of 5 to 20 pounds, or mechanical clips designed to flex elastically during installation and removal cycles exceeding 10,000 repetitions without failure.

The cutting board apparatus may be manufactured using various polymer processing techniques including injection molding, compression molding, or rotational molding for thermoplastic materials. When utilizing injection molding, typical processing parameters include melt temperatures of 400-500° F. for polyethylene materials, injection pressures of 10,000-20,000 psi, and cooling times of 30-120 seconds depending on wall thickness. For bamboo or wood implementations, computer-controlled CNC routing may be employed to machine the groove features with positional accuracy of +0.001 inches, followed by application of food-safe finishes such as mineral oil, beeswax compounds, or polyurethane coatings meeting FDA regulations for food contact surfaces.

The anti-slip elements referenced herein may comprise thermoplastic rubber compounds having a Shore A durometer of 40-80, silicone rubber formulations with coefficients of friction exceeding 1.0 on common countertop materials, or polyurethane foam pads with closed-cell structures preventing moisture absorption. These elements may be attached using pressure-sensitive adhesives rated for shear strengths of 20-50 psi, mechanical fasteners such as stainless steel screws penetrating 0.25-0.5 inches into the base member, or through co-molding processes where the anti-slip material is injection molded directly onto the base member substrate during manufacturing.

Materials suitable for constructing the cutting board apparatus must meet food safety requirements as specified in FDA regulations 21 CFR 177.1520 for polyethylene materials or equivalent standards for other materials. Acceptable plastics include ultra-high molecular weight polyethylene (UHMWPE) with molecular weights exceeding 3 million g/mol, polypropylene homopolymers and copolymers with melt flow indices of 2-20 g/10 min, or polyoxymethylene (POM) resins providing superior hardness and chemical resistance. Natural materials such as bamboo should be sourced from species like Phyllostachys edulis processed using formaldehyde-free adhesives, while hardwoods should comprise close-grained species such as hard maple (Acer saccharum), black walnut (Juglans nigra), or teak (Tectona grandis) with moisture contents below 8% to prevent warping.

Unless expressly stated otherwise, words such as “a,” “an,” and “the” are intended to include both singular and plural forms, and the term “about” is intended to accommodate ±10% variations in stated values. Recitation of a range inherently includes all sub-ranges and individual values within that range. All exemplary materials, temperatures, and dimensions may be interchanged with other functionally equivalent counterparts unless contradicted by express language. The scope of the invention should therefore be construed in light of the appended claims, with these passages serving only to illustrate representative but non-limiting embodiments.

### DESCRIPTION OF DRAWINGS

The present invention provides an innovative cutting board apparatus that fundamentally transforms the food preparation experience by addressing the longstanding limitations of conventional cutting boards through an elegantly simple yet highly effective design. Unlike traditional flat cutting boards that allow food items to scatter freely during cutting operations, the present invention incorporates a comprehensive sidewall system that creates a controlled preparation environment while maintaining the flexibility needed for efficient ingredient transfer. The cutting board apparatus features three permanently affixed sidewalls that establish a containment perimeter around the majority of the cutting surface, complemented by a fourth sidewall that can be selectively removed to create an unobstructed pathway for ingredient transfer when needed.

This dual-mode functionality represents a significant advancement over prior art cutting boards that force users to choose between containment and transferability. When all four sidewalls are in place, the apparatus provides complete perimeter protection that prevents even the most energetic chopping operations from propelling food items onto surrounding surfaces. This containment capability dramatically reduces food waste, eliminates the safety hazards created by scattered ingredients on kitchen floors, and maintains the cleanliness of the food preparation area. The sidewalls also enable users to effectively segregate different ingredients on the same cutting surface, such as separating unusable trimmings from prepared ingredients, without risk of unintended mixing or cross-contamination.

One innovative aspect of the invention lies in the removable nature of the fourth sidewall, which can be quickly and easily disengaged from its retention mechanisms to convert the contained cutting environment into an open-edge design optimized for ingredient transfer. This removal process requires no tools and can be accomplished with a simple upward sliding motion, allowing users to seamlessly transition from cutting to transfer operations. Once removed, the open edge permits cut ingredients to be efficiently scraped or pushed directly into waiting cooking vessels, storage containers, or waste receptacles without the awkward maneuvering required by traditional cutting boards.

The invention solves multiple problems that have plagued food preparation activities since the inception of flat cutting boards. First, it eliminates the inefficiency caused by ingredients scattering beyond the cutting surface, which traditionally requires users to interrupt their workflow to gather escaped items. Second, it removes the need for improvised containment methods such as strategically placed towels or the user's free hand to block food from falling off the board. Third, it addresses the transfer challenge that exists with fixed-edge cutting boards, which require users to either dangerously tilt heavy boards laden with ingredients or laboriously scoop ingredients over raised barriers.

Furthermore, the design accommodates modern cooking practices that emphasize mise en place preparation, where multiple ingredients must be prepared in advance and kept organized until needed. The sidewall system allows users to maintain distinct zones on the cutting surface for different ingredients while providing confidence that rapid chopping motions will not cause unintended mixing. When sequential transfer of different ingredients is required, the removable sidewall can be repeatedly installed and removed as needed, providing unprecedented flexibility in managing complex food preparation tasks.

The structural design of the apparatus also addresses practical concerns related to sanitation and maintenance. The smooth transitions between the cutting surface and sidewalls, achieved through curved surface profiles, eliminate the sharp corners and crevices that traditionally harbor food particles and bacterial growth. This design consideration extends to the retention mechanisms for the removable sidewall, which are configured to prevent food accumulation while maintaining their mechanical function through repeated use cycles. The ability to completely remove one sidewall also facilitates thorough cleaning of the entire cutting surface and all interior corners, a significant advantage over fixed-perimeter designs that can impede access during cleaning operations.

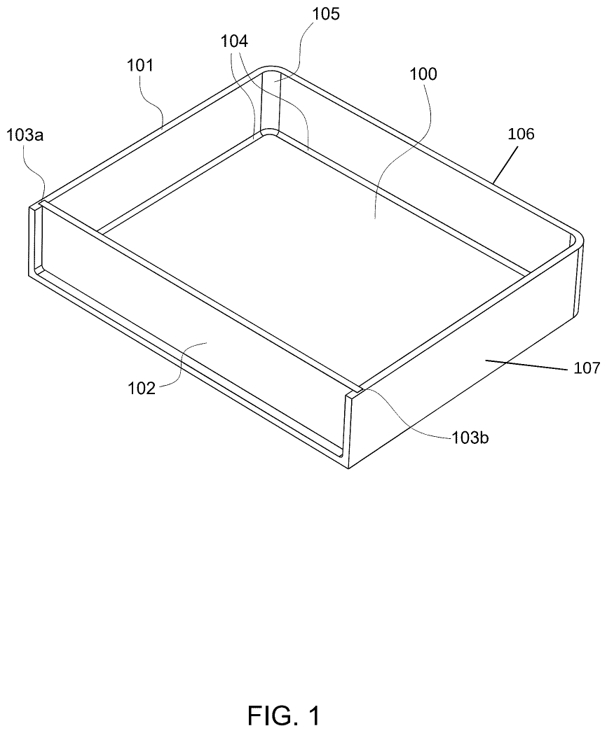

Referring now to FIG. 1, a perspective view illustrates the cutting board apparatus in its fully assembled configuration with all four sidewalls in position to provide complete perimeter containment during food preparation operations. The main chopping surface 100 forms the primary work area where cutting, chopping, dicing, and other food preparation activities are performed. The chopping surface 100 may be constructed from various food-safe materials including high-density polyethylene (HDPE), ultra-high molecular weight polyethylene (UHMWPE), polypropylene, bamboo, hardwoods such as maple or walnut, or composite materials meeting FDA regulations for food contact surfaces. The surface 100 may incorporate various textures or patterns to enhance its cutting performance, such as a slightly textured finish to prevent slippage of ingredients while maintaining ease of cleaning, or may feature a smooth finish optimized for tasks requiring precise knife control.

The left sidewall 101, back sidewall 106, and right sidewall 107 extend upwardly from their respective edges of the base member, creating three sides of the containment perimeter. These sidewalls may be integrally formed with the base member through injection molding processes when utilizing thermoplastic materials, or may be separately attached using food-safe adhesives, mechanical fasteners, or interlocking joint systems when constructed from wood or bamboo materials. The height of these sidewalls above the chopping surface 100 may range from 0.5 inches for compact boards designed for herb preparation to 3.0 inches for commercial-grade boards intended for high-volume food processing, with the specific height optimized based on the overall dimensions of the cutting board to prevent interference with natural wrist and hand motions during cutting operations.

The removable front sidewall 102 completes the perimeter containment system and is shown secured within grooves 103a and 103b located on the forward portions of the left sidewall 101 and right sidewall 107 respectively. The sidewall 102 may be manufactured from the same material as the other components for aesthetic unity or may comprise a different material selected for specific properties such as transparency to allow visual monitoring of ingredient levels, or a contrasting color to clearly indicate its removable nature. The thickness of the removable sidewall 102 is precisely controlled to provide adequate structural rigidity while maintaining smooth sliding engagement with the retention grooves.

The transition area 104 between the main chopping surface 100 and each of the sidewalls represents a critical design feature that eliminates sharp internal corners where food particles might otherwise accumulate. This transition 104 comprises a smoothly curved surface profile, facilitating both the movement of ingredients across the surface and the cleaning of the apparatus. The curved profile may be achieved through CNC machining operations for wood or bamboo implementations, or incorporated directly into injection mold tooling for plastic versions. Similarly, the corner areas 105 where adjacent sidewalls meet feature rounded profiles that may utilize compound curves to create smooth transitions in three dimensions, further enhancing cleanability and preventing food particle entrapment.

The grooves 103a and 103b serve as the retention mechanisms for the removable sidewall 102 and may be configured in various ways beyond simple rectangular channels. These grooves may incorporate dovetail profiles that prevent outward movement of the sidewall 102 under lateral forces, T-shaped cross-sections that provide mechanical interlocking, or may feature elastomeric inserts that create controlled friction to maintain the sidewall position while allowing smooth removal when desired. The depth of these grooves typically ranges from 0.25 to 0.75 inches, with the specific dimension selected to provide adequate engagement while preventing the sidewall 102 from being dislodged during normal use.

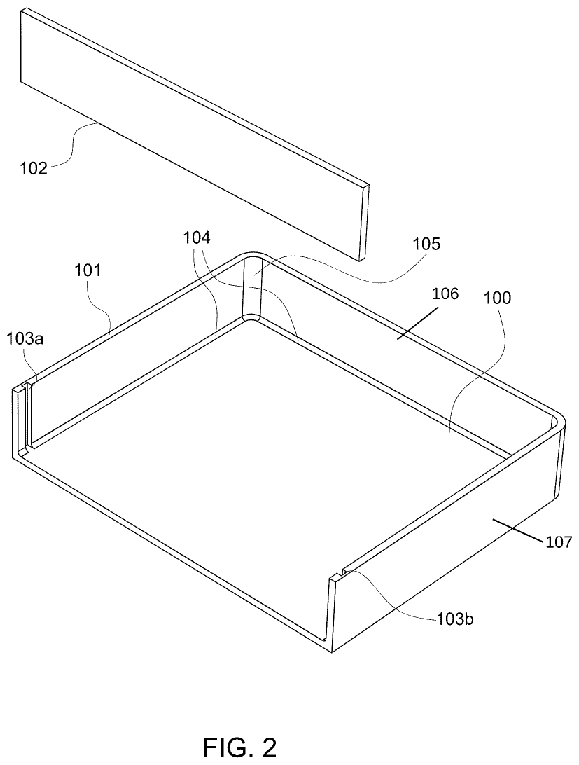

FIG. 2 presents a front perspective view of the cutting board apparatus with the removable front sidewall 102 lifted out of the retention grooves and separated from the main board assembly. This configuration illustrates the apparatus in its transfer mode, where the open front edge created by the removal of sidewall 102 provides unobstructed access for moving prepared ingredients from the chopping surface 100 into cooking vessels or storage containers. The grooves 103a and 103b are clearly visible in this view, revealing their internal configuration which may include smooth machined surfaces for plastic implementations or may incorporate wear-resistant inserts such as UHMWPE strips or stainless steel channels for enhanced durability in commercial applications.

The separation of the removable sidewall 102 demonstrates the ease with which the component can be disengaged from the retention system. In operation, the user applies an upward force to overcome any retention features such as friction fits or magnetic attractions that may be incorporated to prevent inadvertent dislodgment. Alternative embodiments may feature spring-loaded ball detents within the grooves that provide tactile feedback during insertion and removal, or may utilize magnetic strips embedded within both the sidewall 102 and the adjacent surfaces of grooves 103a and 103b, employing neodymium magnets providing holding forces of 5 to 20 pounds while still permitting manual removal.

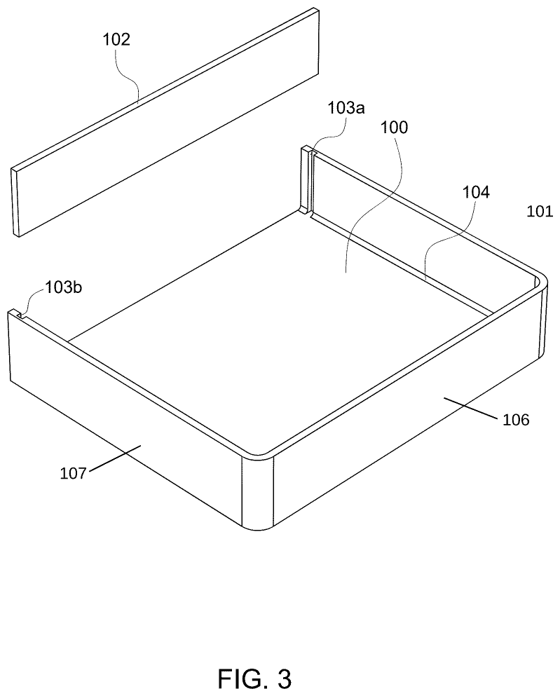

FIG. 3 shows a rear perspective view of the cutting board apparatus, again with the removable front sidewall 102 separated from the main assembly. This view emphasizes the robust construction of the back sidewall 106 and its integration with the left sidewall 101 and right sidewall 107. The three fixed sidewalls may be oriented perpendicular to the chopping surface 100 or may feature a slight outward angle ranging from 1 to 15 degrees from vertical, which not only facilitates cleaning of the interior corners but also enables efficient nesting of multiple cutting board units for space-efficient storage in commercial kitchens or during shipping.

The underside features of the cutting board apparatus, while not directly visible in this perspective, would typically include anti-slip elements positioned at strategic locations to prevent movement during use. These elements may comprise discrete rubberized feet located at the four corners and potentially at intermediate positions along the edges for larger boards, or may consist of continuous strips of high-friction material applied along the entire perimeter of the bottom surface. The anti-slip elements may be attached using pressure-sensitive adhesives rated for repeated washing cycles, or may be mechanically fastened using countersunk screws that do not protrude beyond the bottom plane of the anti-slip elements themselves.

The sidewall heights shown may be uniform around the entire perimeter or may vary, with some embodiments featuring higher back and side walls to provide enhanced containment for vigorous chopping operations while maintaining a lower front wall height to facilitate ergonomic access. The corners where the removable sidewall 102 meets the fixed sidewalls when installed may incorporate overlapping configurations, tongue-and-groove joints, or magnetic alignment features to ensure proper positioning and prevent gaps that might allow food particles to escape the contained area.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the cutting board apparatus of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A cutting board apparatus comprising:
a base member having a cutting surface;
a first sidewall extending upwardly from a first edge of said base member;
a second sidewall extending upwardly from a second edge of said base member, wherein said second edge is opposite to said first edge;
a third sidewall extending upwardly from a third edge of said base member, wherein said third edge extends between said first edge and said second edge;
a fourth sidewall removably coupled to said base member at a fourth edge thereof, wherein said fourth edge is opposite to said third edge and extends between said first edge and said second edge;
a first retention mechanism disposed on said first sidewall proximate to said fourth edge; and
a second retention mechanism disposed on said second sidewall proximate to said fourth edge,
wherein said fourth sidewall is configured to engage with said first retention mechanism and said second retention mechanism to secure said fourth sidewall in an installed position relative to said base member, and
wherein said fourth sidewall is configured to disengage from said first retention mechanism and said second retention mechanism to permit removal of said fourth sidewall from said base member.

2. The cutting board apparatus of claim 1, wherein said first retention mechanism comprises a first groove formed in said first sidewall, and wherein said second retention mechanism comprises a second groove formed in said second sidewall.

3. The cutting board apparatus of claim 2, wherein said fourth sidewall comprises a first lateral edge configured to slidably engage with said first groove and a second lateral edge configured to slidably engage with said second groove.

4. The cutting board apparatus of claim 3, wherein said fourth sidewall is configured to be removed by sliding said fourth sidewall in an upward direction relative to said base member.

5. The cutting board apparatus of claim 1, wherein said base member, said first sidewall, said second sidewall, and said third sidewall are integrally formed as a unitary structure.

6. The cutting board apparatus of claim 1, wherein said cutting surface comprises a transition region between said cutting surface and each of said first sidewall, said second sidewall, and said third sidewall, wherein each said transition region comprises a curved surface.

7. The cutting board apparatus of claim 6, wherein corner regions formed between adjacent sidewalls of said first sidewall, said second sidewall, and said third sidewall comprise curved surfaces.

8. The cutting board apparatus of claim 1, wherein said base member and said sidewalls comprise high-density polyethylene.

9. The cutting board apparatus of claim 1, wherein said base member and side walls comprise at least one material selected from the group consisting of polyethylene, polypropylene, bamboo, wood, and composite materials.

10. The cutting board apparatus of claim 1, further comprising a plurality of anti-slip elements disposed on a bottom surface of said base member opposite to said cutting surface.

11. The cutting board apparatus of claim 10, wherein said plurality of anti-slip elements comprise rubberized feet.

12. The cutting board apparatus of claim 1, wherein each of said first sidewall, said second sidewall, said third sidewall, and said fourth sidewall extends to a predetermined height above said cutting surface.

13. The cutting board apparatus of claim 12, wherein said predetermined height is selected based on a dimensional size of said cutting surface.

14. The cutting board apparatus of claim 1, wherein at least one of said first sidewall, said second sidewall, said third sidewall, and said fourth sidewall is oriented at an outward angle relative to a perpendicular direction from said cutting surface.

15. The cutting board apparatus of claim 14, wherein said outward angle is configured to permit nesting of multiple cutting board apparatuses.

16. The cutting board apparatus of claim 1, wherein said base member and at least one of said sidewalls comprise different materials.

17. The cutting board apparatus of claim 1, wherein said first sidewall, said second sidewall, and said third sidewall are detachably coupled to said base member.

18. The cutting board apparatus of claim 1, wherein said base member comprises bamboo having antimicrobial properties.

19. The cutting board apparatus of claim 1, wherein said first retention mechanism and said second retention mechanism are positioned at a front portion of said first sidewall and said second sidewall, respectively.

20. The cutting board apparatus of claim 1, wherein said cutting board apparatus is manufactured by injection molding, wherein said base member, said first sidewall, said second sidewall, and said third sidewall are formed as a first molded component, and wherein said fourth sidewall is formed as a second molded component separate from said first molded component.
